(19) United States
(12) Patent Application Publication
(10) Pub. No.: US 2020/0331388 A1
(43) Pub. Date: Oct. 22, 2020

(54) IMAGE DISPLAY SYSTEM

(71) Applicant: AISIN SEIKI KABUSHIKI KAISHA, Kariya-shi, Aichi-ken (JP)

(72) Inventors: Kosuke HIRANO, Kariya-shi (JP); Norichika YAMASHITA, Kariya-shi (JP)

(73) Assignee: AISIN SEIKI KABUSHIKI KAISHA, Kariya-shi, Aichi-ken (JP)

(21) Appl. No.: 16/305,574

(22) PCT Filed: Mar. 24, 2017
(86) PCT No.: PCT/JP2017/011923

§ 371 Date: Nov. 29, 2018

(30) Foreign Application Priority Data
May 30, 2016 (JP) 2016-107651

(51) Int. Cl. B60R 1/00; B60Q 9/00; G06T 7/13; G06T 7/70; H04N 5/225; H04N 7/18; G06K 9/00

(52) U.S. Cl. CPC B60R 1/00; B60Q 9/00; G06T 7/13; G06T 7/70; H04N 5/2253; G08G 1/16; G06K 9/00805; B60R 2300/10; B60R 2300/20; G06T 2207/30261; H04N 7/183

(57) ABSTRACT

An image display system includes an image capturing unit that is to be mounted on a vehicle, and is configured to capture an image of surroundings of the vehicle, a display unit configured to display a captured image captured by the image capturing unit, a stationary object detection unit configured to detect a stationary object contained in the captured image and a position of the stationary object in the captured image, a determination unit configured to determine whether or not the position of the stationary object in the captured image has changed, based on a plurality of the captured images successively captured while the vehicle is traveling, and a notification unit configured to provide a notification if it is determined by the determination unit that the position of the stationary object has not changed.

### TECHNICAL FIELD

The present invention relates to an image display system that displays, on a display unit, a captured image captured by an image capturing unit that is mounted on a vehicle.

### BACKGROUND ART

An image display system including a vehicle-mounted image capturing unit and a display unit on which an image captured by the image capturing unit is displayed is used as a device for assisting driving of a vehicle such as an automobile. Occasionally, a failure may occur in the image capturing unit, resulting in a state (hereinafter referred to as “freeze”) in which the captured image displayed on the display unit is fixed and does not change. When the captured image freezes, the displayed image does not change even when the vehicle is moving, making it impossible to assist driving.

Therefore, the imaging display system described in Patent Document 1 includes a difference detection means that detects a difference between image frames that are successively output from an image capturing unit, and a notification means that provides a notification when no difference is detected between successive image frames by the difference detection means. In this imaging display system, utilizing the fact that no difference is detected between successive image frames if the captured image is frozen, a notification indicating that a captured image has frozen is provided to the user.

### PRIOR ART DOCUMENTS

### Patent Documents

Patent Document 1: JP 2004-64440A

### DISCLOSURE OF THE INVENTION

### Problem to be Solved by the Invention

According to the technique described in Patent Document 1, the difference detection means detects a difference between successive image frames that are output from the image capturing unit. Accordingly, a buffer for temporarily storing image data is required for each vehicle-mounted camera, and because the data for an entire image is used in the detection of difference, the buffer capacity and the computation amount are increased, thus leaving for room for improvement.

Therefore, there is a need for an image display system that can detect an abnormality in the image capturing unit using a simple configuration.

### Means for Solving Problem

A characteristic feature of an image display system according to the present invention, the image display system comprises:

an image capturing unit that is to be mounted on a vehicle, and is configured to capture an image of surroundings of the vehicle;

a display unit configured to display a captured image captured by the image capturing unit;

a stationary object detection unit configured to detect a stationary object contained in the captured image and a position of the stationary object in the captured image;

a determination unit configured to determine whether or not the position of the stationary object in the captured image has changed based on a plurality of the captured images successively captured while the vehicle is traveling; and

a notification unit configured to provide a notification if it is determined by the determination unit that the position of the stationary object has not changed.

If the position of the stationary object does not change in successive captured images while the vehicle is traveling, it is highly likely that an abnormality in the image capturing unit has caused a captured image to freeze. Therefore, according to this configuration, the stationary object detection unit detects a stationary object contained in the captured image while the vehicle is traveling. If the determination unit has determined that the position of the stationary object in successive captured images has not changed, a notification is provided by the notification unit. That is, the determination unit performs the determination based on the stationary object that forms a portion of a captured image, and thus the computation speed for the determination is faster compared to a case where the determination is performed based on a difference between entire captured images as in the conventional techniques. Therefore, the driver can be promptly notified of an abnormality in the image capturing unit. Moreover, the amount of data of the stationary object in the captured image is significantly smaller than the amount of data of an entire captured image, and it is thus possible to decrease the capacity of an image buffer for determining the presence of a captured image abnormality.

Another characteristic feature of an image display system according to the present invention lies in that the determination unit performs the determination based on the position of the edge portion of the stationary object.

With this configuration, the determination unit determines whether or not the position of the stationary object in the captured image has changed, based on the position of an edge portion of the stationary object. By using the position information of the edge portion of the stationary object in this manner, it is possible to further reduce the amount of data of the captured image that is used for the above-described determination.

Another characteristic feature of the image display system according to the present invention lies in that the determination unit performs the determination based on a position of a portion of the stationary object detected by the stationary object detection unit, the portion being non-parallel to an advancing direction of the vehicle.

Of the stationary object contained in the captured image, a portion that is located along the advancing direction of the vehicle hardly undergoes positional change in successive captured images even when the display image is normal while the vehicle is traveling. Accordingly, it may not be possible to accurately detect a display image abnormality.

Therefore, in the present configuration, the determination unit performs the determination based on the position of a portion of the stationary object detected by the stationary object detection unit that is non-parallel to the advancing direction of the vehicle. The portion that is non-parallel to the advancing direction of the vehicle is a portion whose position will certainly change in the captured image as the vehicle travels. Accordingly, it is possible to accurately detect an abnormality such as the occurrence of a freeze of the captured image.

### BRIEF DESCRIPTION OF THE DRAWINGS

FIG. 1 is a block diagram of an image display system.

FIG. 2 is a flowchart illustrating a determination procedure.

FIG. 3 is a diagram showing a display screen of a display unit.

### BEST MODE FOR CARRYING OUT THE INVENTION

In the following, an embodiment of the present invention will be described in detail with reference to the drawings.

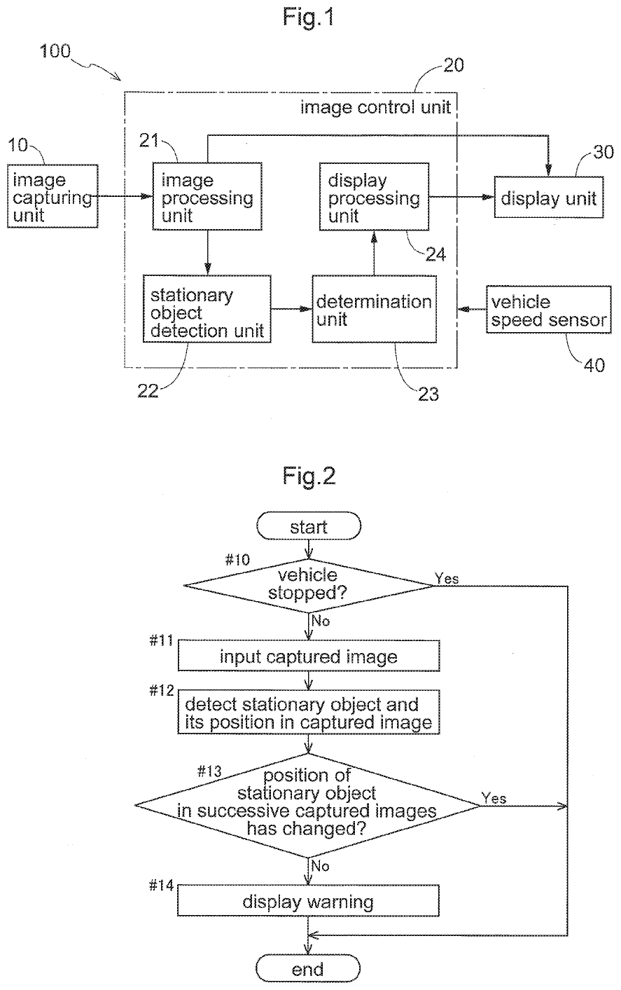

An image display system 100 shown in FIG. 1 displays captured images of the surroundings of a vehicle that are captured by an image capturing unit 10 mounted on the vehicle.

As shown in FIG. 1, the image display system 100 includes an image capturing unit 10, an image control unit 20, and a display unit 30. The image capturing unit 10 includes a camera using, for example, a CCD or the like, and is mounted on a vehicle and captures images of the surroundings of the vehicle. A captured image that has been input from the image capturing unit 10 is subjected to image processing or the like by the image control unit 20, and is then output to the display unit 30. The display unit 30 is provided in an internal space or the like of the vehicle, and displays a captured image captured by the image capturing unit 10. The image capturing unit 10, the image control unit 20, and the display unit 30 are connected to each other via a wired connection or a wireless connection.

The image control unit 20 includes an image processing unit 21, a stationary object detection unit 22, a determination unit 23, and a display processing unit 24. These functional units are each configured by software centered on a CPU executing various types of processing or on a memory, or hardware and software working in conjunction with each other. The image processing unit 21 performs image processing for displaying, on the display unit 30, a captured image obtained from the image capturing unit 10. The captured image that has been processed by the image processing unit 21 is output to the display unit 30 for display, and is also output to the stationary object detection unit 22. The stationary object detection unit 22 detects a stationary object contained in the captured image that has been input from the image processing unit 21, and the position of the stationary object in the captured image.

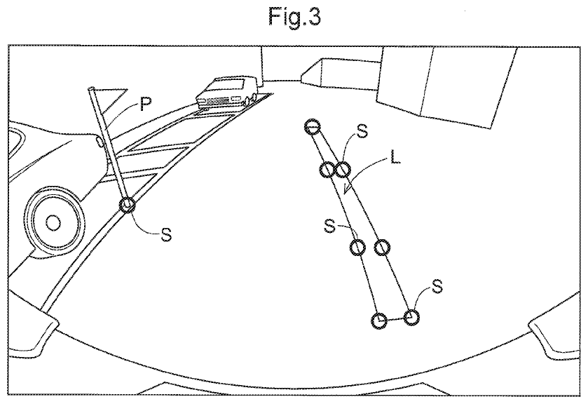

Here, a stationary object is an object that is present in the surroundings of the vehicle, and whose position will not change. For example, a stationary object corresponds to all objects present on the ground (ground objects), including a division line L such as a white line and a frame line provided on the road surface, a sign, and a pole P that are contained in the display image shown in FIG. 3. The stationary object contained in the captured image is detected based on the shape, luminance information, and the like. For example, the division line L provided on the road surface can be detected by using a known automatic recognition technique. The stationary object detection unit 22 detects a stationary object (e.g., the division line L), for example, by extracting edges from the captured image. More specifically, the stationary object detection unit 22 detects a stationary object by extracting a luminance change point (feature point) that is greater than or equal to a prescribed threshold. The stationary object detection unit 22 may perform the detection by using one such stationary object, or two or more of the stationary objects in combination.

The determination unit 23 determines whether or not the position of the stationary object in the captured image detected by the stationary object detection unit 22 has changed, based on a plurality of captured images successively captured while the vehicle is traveling. The vehicle is provided with a vehicle speed sensor 40 that detects the movement speed. The vehicle speed sensor 40 is connected to the image control unit 20, and the speed data of the vehicle is input to the image control unit 20 from the vehicle speed sensor 40. If it is determined that the vehicle is in a stopped state, based on the speed data obtained from the vehicle speed sensor 40, the image control unit 20 does not perform the detection and the determination of the stationary object in the captured image. Conversely, if it is determined that the vehicle is in the traveling state, the image control unit 20 performs the detection and determination of the position of the stationary object in the captured image.

If it is determined by the determination unit 23 that the position of a stationary object in the captured image has not changed, the display processing unit 24 provides a notification to the display unit 30 by sending an alert message thereto.

Thus, the stationary object detection unit 22 sends the position data of the detected stationary object in the captured image to the determination unit 23. Then, the determination unit 23 determines whether or not the position of the stationary object in the captured image has changed, based on the position data.

If the position of the stationary object in successive captured images has not changed, it is highly likely that an abnormality in the image capturing unit has caused a captured image to freeze. Accordingly, if it is determined that the position of the stationary object contained in successive captured images has not changed, the determination unit 23 sends an instruction signal based on that determination to the display processing unit 24. Upon receiving the instruction signal from the determination unit 23, the display processing unit 24 outputs an alert message (notification message) and an instruction to display the alert message to the display unit 30. The alert message is stored in a ROM (not shown) of the display processing unit 24. The display processing unit 24 operates as a notification unit that provides a notification indicating that the captured image has frozen if there is no change in the position of the stationary object in successive captured images.

The display unit 30 is capable of composite display (superimposed display) in which characters (alert message) are displayed overlapping a display image. The display processing unit 24 sends an alert message and an instruction for superimposed display to the display unit 30, and causes the display unit 30 to display the alert message in a superimposed manner.

A procedure for the detection of freezing of the captured image and the alert display performed in the image display system 100 will be described with reference to the flowchart shown in FIG. 2.

First, whether or not the vehicle is stopped is checked based on the speed data from the vehicle speed sensor 40 (step #10). Based on the speed data of the vehicle speed sensor 40, if the vehicle speed is zero, or less than or equal to a predetermined speed, it is determined that the vehicle is stopped (step #10, Yes), and the subsequent processing will not be performed.

If it is determined that the vehicle is travelling at a vehicle speed exceeding the predetermined speed (step #10, No), a captured image is input from the image processing unit 21 to the stationary object detection unit 22 (step #11). In the stationary object detection unit 22, a stationary object contained in the captured image and the position of the stationary object are detected (step #12). Next, the position data of the stationary object is input from the stationary object detection unit 22 to the determination unit 23, and the determination unit 23 determines whether or not the position of the stationary object in the captured image has changed (step #13). If it is determined by the determination unit 23 that the position of the stationary object in successive captured images has not changed (step #13, No), a signal instructing the display processing unit 24 to display a warning such as an alert message is sent from the determination unit 23, and the warning is displayed on the display unit 30 (step #14).

The stationary object detection unit 22 may detect the entire stationary object contained in the captured image, or may detect a portion of the stationary object. Specifically, the stationary object detection unit 22 may detect an edge portion of the stationary object and the position of the edge portion in the captured image. In that case, the determination unit 23 performs the determination based on the position of the edge portion of the stationary object. An edge portion of the stationary object may be, for example, an end portion S or the like of the division line L on the road surface shown in FIG. 3. Note that the determination based on the position of the edge portion of the stationary object may be performed based on one edge portion of the stationary object, or may be performed based on a line segment connecting a plurality of edge portions.

Thus, as a result of the determination unit 23 making a determination based on the position of an edge portion or the like, which is a portion of the stationary object, it is possible to further reduce the amount of data used to detect an abnormality in successive captured images.

Of the stationary object contained in the captured image, a portion located along the advancing direction of the vehicle hardly undergoes positional change in successive captured images even when the captured image is displayed normally. Accordingly, it may be determined by the determination unit 23 that the position of the captured image in the stationary object has not changed even when successive captured images are normally displayed.

Therefore, it is preferable that the stationary object detection unit 22 detects the position of a portion of the stationary object contained in the captured image that is non-parallel to the advancing direction of the vehicle. The portion of the stationary object that is non-parallel to the advancing direction of the vehicle corresponds, for example, to a pole P that is provided standing upright on the road surface and a division line L that is inclined relative to the advancing direction of the vehicle that are shown in FIG. 3. The portion of the stationary object that is non-parallel to the advancing direction of the vehicle is a portion whose position in the captured image will definitely change as the vehicle advances. Accordingly, an abnormality in successive captured images can be reliably detected by the determination unit 23.

### Alternative Embodiments

(1) In the above embodiment, an example is shown in which the image capturing unit 10 and the display unit 30 are connected to the image control unit 20; however, the image control unit 20 may be provided inside the display unit 30, and the image capturing unit 10 may be connected to the display unit 30.

(2) In the above embodiment, an example is shown in which the image capturing unit 10 is constituted by one camera; however, the image capturing unit 10 may include a plurality of cameras.

(3) In the above embodiment, an example is shown in which the display processing unit 24 is provided as the notification unit, and a warning is displayed on the display unit 30; however, the notification unit is not limited to the display processing unit 24, and may be a unit that provides a warning by using sound or light generated by a speaker, a warning light, or the like that is provided inside the vehicle.

### INDUSTRIAL APPLICABILITY

The present invention can be widely used for an image display system that is mounted on a moving object such as a vehicle.

### DESCRIPTION OF REFERENCE SIGNS

10: camera (image capturing unit)
20: image control unit
21: image processing unit
22: stationary object detection unit
23: determination unit
24: display processing unit (notification unit)
30: display unit
40: vehicle speed sensor
100: image display system
L: division line (stationary object)
S: end portion (edge portion)

1. An image display system comprising:
an image capturing unit that is to be mounted on a vehicle, and is configured to capture an image of surroundings of the vehicle;
a display unit configured to display a captured image captured by the image capturing unit;
a stationary object detection unit configured to detect a stationary object contained in the captured image and a position of the stationary object in the captured image;
a determination unit configured to determine whether or not the position of the stationary object in the captured image has changed, based on a plurality of the captured images successively captured while the vehicle is traveling; and
a notification unit configured to provide a notification if it is determined by the determination unit that the position of the stationary object has not changed.

2. The image display system according to claim 1, wherein
the stationary object detection unit detects an edge portion of the stationary object contained in the captured image and a position of the edge portion in the captured image, and
the determination unit performs the determination based on the position of the edge portion.

3. The image display system according to claim 1, wherein
the determination unit performs the determination based on a position of a portion of the stationary object detected by the stationary object detection unit, the portion being non-parallel to an advancing direction of the vehicle.
